(19) United States
(12) Patent Application Publication
(10) Pub. No.: US 2006/0162854 A1
(43) Pub. Date: Jul. 27, 2006

(54) Process and apparatus for producing a honeycomb body

(75) Inventor: Kait Althofer, Wiehl (DE)

Correspondence Address: LERNER GREENBERG STEMER LLP, P O BOX 2480, HOLLYWOOD, FL, 33022-2480, US

(73) Assignee: Emitech Gesellschaft fur Emissionstechnologie mbH

(21) Appl. No.: 11/359,948

(22) Filed: Feb. 21, 2006

Related U.S. Application Data
(63) Continuation of application No. PCT/EP04/08804, filed on Aug. 6, 2004.

(30) Foreign Application Priority Data
Aug. 21, 2003 (DE) 103 38 360.3

(51) Int. Cl. B31F 1/20

(52) U.S. Cl. 156/210

(57) ABSTRACT

A process and an apparatus for producing metallic honeycomb bodies, for treating exhaust gas of mobile internal combustion engines, provide components of the honeycomb body with a bonding agent prior to a brazing process. The bonding agent is applied with precision to predetermined subregions in drop form. The bonding agent is preferably applied by using ink-jet, bubble-jet or drop-on-demand technology. A simple production of honeycomb bodies having sheet metal and a non-uniform flexibility over a direction of flow and/or in a direction transverse to the direction of flow, is provided.

### CROSS-REFERENCE TO RELATED APPLICATION

This is a continuing application, under 35 U.S.C. §120, of copending International Application PCT/EP2004/008804, filed Aug. 6, 2004, which designated the United States; this application also claims the priority, under 35 U.S.C. §119, of German Patent Application 103 38 360.3, filed Aug. 21, 2003; the prior applications are herewith incorporated by reference in their entirety.

### BACKGROUND OF THE INVENTION

### FIELD OF THE INVENTION

The present invention relates to a process and an apparatus for producing honeycomb bodies from layers, as are used in particular as catalyst carrier bodies, adsorbers and/or filter bodies in the automotive industry.

Honeycomb bodies which are wound or stacked and intertwined from layers, in particular metallic layers, are known in numerous forms. A distinction is drawn in particular between two typical forms of honeycomb bodies constructed from layers. An early structure, of which German Published, Non-Prosecuted Patent Application DE 29 02 779 A1, corresponding to U.S. Pat. No. 4,273,681, shows typical examples, is the helical structure, in which substantially one smooth and one corrugated sheet-metal layer are placed on top of one another and wound up helically. In another structure, the honeycomb body is constructed from a multiplicity of alternately disposed smooth and corrugated or differently corrugated sheet-metal layers, with the sheet-metal layers initially forming one or more stacks, that are intertwined together. In that case, the ends of all of the sheet-metal layers come to lie on the outside and can be connected to a housing or tubular casing, resulting in the formation of numerous connections, which increase the durability of the honeycomb body. Typical examples of those structures are described in European Patent EP 0 245 737 B1, corresponding to U.S. Pat. Nos. 4,946,822; 4,923,109; 4,832,998 and 4,803,189, or International Publication No. WO 90/03220, corresponding to U.S. Pat. Nos. 5,139,844; 5,135,794 and 5,105,539.

The layers have to be connected to one another to produce a honeycomb body. Various connection techniques are possible for achieving the connections. Brazing processes, in which the layers are brazed together at least in subregions, have gained considerable commercial importance. For that purpose, it is necessary to introduce an additional material, the brazing material, which has a lower melting point than the layers, into the honeycomb body. As a result of the honeycomb body being heated to above the melting point of the brazing material, the brazing material melts, and the layers are connected to one another as it cools.

The brazing material can be introduced into the honeycomb body in various forms, for example as a brazing foil or brazing powder. Brazing foil is inserted or adhesively bonded in the regions in which layers are subsequently to be connected to one another, whereas brazing powder is either introduced into the honeycomb body without a bonding agent or applied through the use of a bonding agent in defined subregions of the honeycomb body.

If the brazing powder is introduced into the honeycomb body without a bonding agent, it is virtually impossible for only defined, for example axially spaced-apart, subregions of the layers to be connected to one another. If a locally inhomogenous connection between the layers, i.e. a connection which cannot be passed through or traversed in the direction of flow and/or substantially transversely to the direction of flow, or a connection of the layers to a tubular casing surrounding the honeycomb body, is desired, it is necessary to apply a bonding agent when using brazing powder.

Various techniques are known for application of the bonding agent. For example, European Patent EP 0 422 000 B2, corresponding to U.S. Patent Application Publication Nos. US 2002/0129890 A1 and US 2001/0013390 A1, discloses the application of a bonding agent through the use of rolling. The application of the bonding agent in that case takes place prior to the winding or stacking of the layers. Furthermore, German Patent 101 51 487 C1, corresponding to U.S. Pat. No. 6,811,071, by way of example, has disclosed application of the bonding agent in liquid form using capillary forces. In that case, the honeycomb body, after the winding or stacking and intertwining of the layers, is brought into contact with a liquid bonding agent, which as a result of capillary forces rises up into the capillaries formed by the contact regions of smooth layers and corrugated layers.

Both of the processes described herein have drawbacks. For example, application of the bonding agent through the use of rolling is relatively complex, and moreover in particular the relative positioning of the rollers with respect to the layers to be provided with bonding agent is susceptible to inaccuracies. Furthermore, the introduction of the bonding agent through the use of capillary forces does not allow selective connection of adjacent layers only in subregions to a sufficiently flexible degree.

### SUMMARY OF THE INVENTION

It is accordingly an object of the invention to provide a process and an apparatus for producing a honeycomb body, which overcome the hereinafore-mentioned disadvantages of the heretofore-known processes and apparatuses of this general type and in which it is easy for layers to be connected even in subregions of the layers.

With the foregoing and other objects in view there is provided, in accordance with the invention, a process for producing a honeycomb body from layers. The process comprises providing at least one at least partially structured layer and/or substantially smooth layer. Bonding agent in drop form is applied at least to at least one subregion of the at least one at least partially structured layer and/or substantially smooth layer. A honeycomb body is produced from the at least one at least partially structured layer and/or substantially smooth layer. Brazing material is applied to the at least one at least partially structured layer and/or substantially smooth layer. A heat treatment step is carried out on the honeycomb body. The at least one at least partially structured layer and/or substantially smooth layer provided with brazing material continues to substantially adhere to the at least one subregion provided with bonding agent.

In accordance with another mode of the invention, the step of producing a honeycomb body includes the stacking of at least one at least partially structured layer and at least one substantially smooth layer to form at least one stack.

In accordance with a further mode of the invention, the step of producing a honeycomb body includes the intertwining of the at least one stack of layers and/or the winding-up of at least one at least partially structured layer and, if appropriate, at least one substantially smooth layer, to form a honeycomb body.

In accordance with an added mode of the invention, the honeycomb body is provided with brazing material in powder form after the step of applying bonding agent and before the step of carrying out a heat treatment.

According to the invention, it is also possible for the brazing material to be applied in liquid form, in particular in drop form. In this context it is preferable for the drops of brazing material to at least partially cover the drops of bonding agent on the layers, and preferably to cover them over the largest possible area. Furthermore, it is also possible in the step of applying bonding agent to apply a brazing paste, in particular a mixture of brazing material in powder form and a viscous bonding agent, in drop form instead of a pure bonding agent.

Applying the bonding agent in drop form has an advantage over the prior art, which is that this application can take place without contact, i.e. without the need for mechanical contact between the device for applying the bonding agent and the layers. Furthermore, according to the invention, the bonding agent is applied prior to the winding or stacking of the layers, so that it is advantageously possible for only subregions of the layers to be provided with bonding agent and subsequently to be connected to one another. It is thus possible to construct honeycomb bodies which are brazed together in some subregions but are not brazed together in other subregions, so that it is therefore possible to realize honeycomb bodies with an inhomogenous connection in a simple way. It is thus advantageously possible to produce honeycomb bodies which are inhomogenous in terms of their elasticity, i.e. have subregions which are more elastic or less elastic than other subregions. If the honeycomb body is used in the exhaust system of a motor vehicle, it is thus possible to produce honeycomb bodies which are adapted to the specific requirements of a particular exhaust system.

Furthermore, the application of the bonding agent in drop form allows a local accuracy of the application of bonding agent which is at least on the order of magnitude of the drop diameters. Therefore, locally very accurate delimiting of the subregions of the layers to which bonding agent is applied can be achieved.

When carrying out the heat treatment step, this step may be a brazing operation in a brazing furnace, but it is also possible to achieve heating by inductive brazing or radiation brazing or else through the use of the waste heat of a welding operation.

The bonding agents used are preferably low-viscosity bonding adhesives, preferably based on a polarizable solvent, in particular water or organic solvents. It is also preferable to use tried-and-tested bonding agents for building up honeycomb bodies.

In accordance with an additional mode of the invention, the bonding agent is applied to an at least partially structured layer in the region of the flanks or sides of the structures, preferably near to a structure extremity.

If, for example, a honeycomb body is built up by winding a substantially smooth layer and an at least partially structured layer, after the winding operation the structure extremities, i.e. the structure minima and structure maxima, of the at least partially structured layer bear against corresponding regions of the substantially smooth layers. The contact regions between the layers, in which a brazed joint is subsequently to be formed, form the stop faces. This brazed joint is effected by the introduction of brazing powder in the vicinity of the structure extremities, so that during brazing at least one and preferably two brazing pockets are formed adjacent the structure extremities. These brazing pockets may, for example, be approximately triangular. If the bonding agent is introduced into the honeycomb body prior to the winding or intertwining of the layers and the brazing material is introduced into the honeycomb body following the winding or intertwining of the layers, brazing pockets are formed directly adjacent the structure extremities, whereas the structure extremity itself makes no contribution to the brazed connection between the layers.

If the bonding agent is applied to the flanks or sides of the structures near to a structure extremity, on one hand during the application of the brazing material the brazing powder adheres accurately in the regions which are subsequently to be connected, whereas no bonding agent is applied to the structure extremity itself. When the honeycomb body is being wound up or when one or more stacks of layers are being intertwined, relative movements occur between the substantially smooth layer and the at least partially structured layer. In this case, the two layers slide substantially on the structure extremities. If glue or adhesive is present on the structure extremity, this relative movement is impeded, making the winding or intertwining operation more difficult. Therefore, applying the bonding agent to the flanks or sides of the structure improves the winding or intertwining properties, yet the bonding of the layers to one another is nevertheless achieved with a high degree of reliability.

In accordance with yet another mode of the invention, the bonding agent is printed on. In this case it is particularly preferable for the bonding agent to be applied by using a drop-on-demand process, a bubble-jet process and/or a continuous-inkjet process.

Drop-on-demand processes are printing processes which are distinguished by the fact that a drop of the bonding agent is produced only when a defined point of the layers is to be printed. If one considers a printing device which can emit a drop of bonding agent and the corresponding region of the layer to which this drop of bonding agent can be applied, therefore, a drop of bonding agent is generated only when the corresponding region of the layer is to be provided with bonding agent. If no bonding agent is to be applied, no drop of bonding agent is produced either.

By contrast, there are also continuous printing processes, in which a continuous jet of bonding agent drops is generated. If a region is not to be printed, this jet of drops is guided by a deflector into a collection device and then does not reach the surface to be printed.

With drop-on-demand systems, it is possible, for example, to generate individual drops of the bonding agent through the use of piezoelectric actuators. Piezoelectric actuators are electromechanical transducers which are based on the piezoelectric effect. In this case, the application of an AC voltage to the piezoelectric element leads to mechanical oscillations. If a nozzle supplied with the substance to be printed on is operated as a piezoelectric transducer, these mechanical oscillations produce drops of the printing material, which leave the nozzle at a relatively high velocity. These drops strike the material that is to be printed and stick to it. It is possible to print certain subregions of the layer and not to print certain subregions by positioning the printing device which, for example, includes the piezoelectric actuator that has just been described. There are various known drop-on-demand processes which are based on piezoelectric transducers. Purely by way of example, mention may be made of piezo-tubes, piezo-disks and piezo-plates.

Another drop-on-demand process is the bubble-jet process. In this case, the drops of bonding agent are not generated through the use of a piezoelectric transducer, but rather are generated by the use of thermal actuators. These are heating elements which are formed in a nozzle and are supplied with the material to be applied by printing, i.e. the bonding agent. These heating elements briefly locally generate a temperature in the nozzle which is well above the boiling point of the bonding agent. The bonding agent begins to locally boil as a film, whereupon a continuous vapor bubble is formed after a short time. This vapor bubble forces a drop of the substance to be applied by printing out of the nozzle. It is possible to reach pressures of 10 bar or more and exit velocities of 10 m/sec or more. The vapor bubble then collapses, whereupon capillary forces cause further bonding agent to be sucked in. In the context of these bubble-jet processes, a distinction is drawn between various printing techniques, which are generally referred to as edge-shooter and side-shooter.

The continuous-inkjet process is a known printing process in which a continuous jet of ink drops is generated. The jet of ink drops effects printing in predetermined subregions by positioning of the print head and/or electrostatic diversion.

If a continuous-inkjet process of this type is used for the application of bonding agent, a continuous jet of bonding agent drops is generated and guided onto the subregions of the layers that are to be provided with bonding agent. The bonding agent drops then adhere to the layer. In particular, the electrostatic diversion advantageously allows not only the printing of points but also the printing of overlapping points, which ideally form lines.

In accordance with yet a further mode of the invention, the bonding agent is applied through a nozzle which is pulse-excited. In this context, the term pulse-excited means that the nozzle is not subject to high-frequency oscillation, but rather the nozzle is excited through the use of a single pulse when a bonding agent drop is to be expelled through the nozzle. Pulse excitation of this type can be generated, for example, by an electrical voltage pulse on a piezoelectric element connected to the nozzle or by a heat pulse at a corresponding heating element. Therefore, in the case of pulse excitation, the nozzle is only excited when a bonding agent drop is required for application to the layer.

In accordance with yet an added mode of the invention, the bonding agent is applied through a nozzle which is excited into high-frequency oscillations. The oscillation excitation of the nozzle in a continuous-inkjet process differs from a drop-on-demand process by virtue of the fact that this excitation takes place on an ongoing basis, so that a continuous jet of bonding agent drops is generated. If certain subregions are not to be printed and the bonding agent drop jet would strike the subregions without further measures being taken, it is necessary to ensure through the use of a deflection device that these bonding agent drops do not reach the layers but rather are trapped beforehand. The term high-frequency oscillations is to be understood in particular as meaning oscillations with a frequency of more than 10 kHz, preferably more than 50 kHz, and particularly preferably 100 kHz or more.

In accordance with yet an additional mode of the invention, the bonding agent is at a pressure of more than 2 bar, and preferably more than 2.5 bar, in the nozzle.

In accordance with still another mode of the invention, the excitation of the nozzle is effected through the use of a piezoelectric element. In this case, the excitation effected through the use of the piezoelectric element, for example in the case of a drop-on-demand system, uses pulse-like excitation of the piezoelectric element and in the case of a continuous-inkjet process, uses a permanent high-frequency excitation of the piezoelectric element.

In accordance with still a further mode of the invention, the excitation takes place at a frequency of at least 50 kHz, preferably at least 60 kHz, and particularly preferably at least 100 kHz. High-frequency excitations of this type in a continuous-inkjet system allow very fast and rapid application of the bonding agent to the regions of the layers that are to be connected. It is thus possible to achieve high production rates, which allow a honeycomb body to be produced with a very short cycle time.

In accordance with still an added mode of the invention, the bonding agent drops are electrostatically charged and electrostatically deflected. It is thus possible, in addition to or as an alternative to mechanical diversion of the print head, to still effect a precision diversion of the jet in order to achieve particularly accurately defined applications of bonding agent.

In accordance with still an additional mode of the invention, bonding agent drops which are not to be applied to the layers are electrostatically diverted into a collection device and recycled. It is thus advantageously possible for drops which are not to be applied to the layers to be deflected, collected and then recycled to a bonding agent reservoir. In this way it is advantageously possible to reduce the consumption of bonding agent.

In accordance with another mode of the invention, the positioning of the bonding agent on the layers is at least partially achieved by targeted electrostatic deflection of the bonding agent drops before they strike the layers. This advantageously allows very accurate positioning of the bonding agent drops on the layer. Positioning of the bonding agent on the layers purely by electrostatic deflection is possible and in accordance with the invention. This can take place very accurately and quickly, so that it is possible to produce honeycomb bodies of a high quality with short production times.

In accordance with a further mode of the invention, the bonding agent drops are generated by briefly heating the bonding agent above its boiling point in a nozzle. The bonding agent in this case continuously fills a thin nozzle, and brief heating to above the boiling point leads to the formation of a vapor bubble, which accelerates a bonding agent drop out of the nozzle. This bonding agent drop can be used to apply the bonding agent to the layer.

In accordance with an added mode of the invention, at least some of the layers are formed as metallic layers, preferably sheet-metal layers and/or metallic fiber layers. Constructing honeycomb bodies according to the invention from metallic layers, in particular from sheet-metal layers and/or metallic fiber layers, advantageously leads to the formation of very durable and heat-resistant honeycomb bodies. These can be used as catalyst carrier bodies for converting at least parts of the exhaust gas of an automobile. Furthermore, honeycomb bodies of this type can also be used as carrier structures for adsorber coatings, i.e. can be used for example to store hydrocarbons or in the exhaust system of an automobile, for example to store one or more components of the exhaust gas and release them again at a later time. By way of example, adsorbers of this type are known for the temporary storage of nitrogen oxides (NOₓ). A further application area for honeycomb bodies of this type is as a filter body in the automotive industry, for example for filtering out particulates. Particulate filters of this type may have an open or closed construction. In the case of an open particulate filter, particulates which are larger than the pore sizes of the filter materials can pass through the filter, whereas this is not the case with closed filter systems. It is also possible and in accordance with the invention for metallic fiber layers to be reinforced with sheet-metal strips.

In accordance with an additional mode of the invention, at least some of the layers are formed from composite material, preferably a composite material including ceramic fibers and metallic material, preferably metallic fibers and/or sheet-metal layers. It is thus advantageously possible to use composite materials, for example in filter bodies, which composite materials include ceramic fibers and/or metallic fibers and may, if appropriate, also be reinforced by applied sheet-metal layers connected to the fiber material. It is equally possible for one subregion of the layer to be formed from a sheet-metal layer and another subregion of the layer to be formed from a ceramic fiber layer.

In accordance with yet another mode of the invention, the bonding agent drops on the layer have a mean diameter of from 0.05 to 0.7 mm, preferably from 0.1 to 0.4 mm, and particularly preferably from 0.1 to 0.3 mm. Bonding agent dots or lines on the layer with a diameter or width as described above allow very accurate definition of the regions in which adjacent layers are connected following the brazing operation.

In accordance with yet a further mode of the invention, the application of the bonding agent preferably takes place in an application direction which is substantially perpendicular to the direction of movement of the layers.

In accordance with yet an added mode of the invention, the application of the bonding agent preferably takes place in an application direction which is substantially perpendicular to a surface of the at least one subregion that is to be provided with bonding agent. In particular, when the bonding agent is applied to the at least partially structured foils, this allows the formation of defined bonding agent drops adjacent the structure extremities, so that it is possible to prevent the application of a wide bonding agent layer to the lateral flanks or sides.

With the objects of the invention in view, there is also provided an apparatus for producing a honeycomb body. The apparatus comprises a device for providing at least one at least partially structured layer and/or substantially smooth layer. A device applies bonding agent at least to at least one subregion of the at least one at least partially structured layer and/or substantially smooth layer. The device for applying bonding agent includes at least one printing device for printing the bonding agent onto the at least one subregion, a bonding agent reservoir and a feed device for feeding bonding agent to the printing device. A device generates a honeycomb body from the at least one at least partially structured layer and/or substantially smooth layer. A brazing material application device provides the honeycomb body with brazing material substantially continuing to adhere to the at least one subregion having been provided with bonding agent. A treatment device heat treats the honeycomb body.

In accordance with another feature of the invention, the device for generating a honeycomb body includes a stacking device, by which at least one at least partially structured layer and at least one substantially smooth layer are stacked to form at least one stack.

In accordance with a further feature of the invention, the device for generating a honeycomb body includes an intertwining device for intertwining the at least one stack of metallic layers and/or a winding-up device for winding up at least one at least partially structured layer and, if appropriate, at least one substantially smooth layer to form a honeycomb body.

The apparatus according to the invention advantageously allows the application of bonding agent for fixing brazing material on layers in order to construct a honeycomb body through the use of a printing technique. In this case, the printing device can be used to apply bonding agent both to the substantially smooth layers and to the at least partially structured layers. In the present context, the term layers is to be understood as meaning in particular metallic layers and/or layers of composite material.

In accordance with an added feature of the invention, the printing device is a drop-on-demand printing device.

In accordance with an additional feature of the invention, the printing device is a bubble-jet printing device.

In accordance with yet another feature of the invention, the printing device is a continuous-inkjet printing device.

All three of these printing devices in principle make it very easy to apply bonding agent. The printing processes on which these printing devices are based are therefore what are known as ink or inkjet processes.

In accordance with yet a further feature of the invention, the printing device has a nozzle for applying the bonding agent, which can be excited into high-frequency or pulse-like oscillations. A nozzle which is excited at high frequency or in pulsed fashion, together with a corresponding printing device, advantageously allows the generation of individual bonding agent drops or bonding agent drop jets, which can be applied to the subregions of the metallic layers that are to be printed.

In accordance with yet an added feature of the invention, the nozzle has a piezoelectric element. A piezoelectric element is an element which operates according to the piezoelectric effect, i.e. an AC electric voltage present at this element is converted into oscillations. In this case, either pulsed excitation by a voltage pulse can be used or it is possible to generate a high-frequency oscillation by applying a high-frequency AC voltage to the piezoelectric element.

In accordance with yet an additional feature of the invention, the printing device has a charging device for electrostatically charging the bonding agent and a deflecting device for deflecting the bonding agent.

In this case it is particularly advantageous for the deflection device to be constructed in electrostatic form, i.e. for deflection of the electrostatically charged drops of the bonding agent to be generated by an electrostatic field.

In accordance with again another feature of the invention, the device for applying bonding agent includes a collection device for collecting bonding agent that has not been applied.

In the case of an inkjet process, such as, for example, the continuous-inkjet process, with correspondingly constructed printing devices, it is necessary to collect bonding agent drops which are not to reach the surface of the metallic layers. In this way it is possible, for example, to provide only certain subregions of a layer with bonding agent. By way of example, it could be advantageous for the flanks or sides of the structures of the at least partially structured layers to be printed with bonding agent. For this purpose, it would be advantageous to use a printing device with a length corresponding to the length of the structures of the at least partially structured layers. If the structures are not to be printed over the entire length, but rather only in subregions, it is then necessary for some of the drops which would strike the regions in which application of bonding agent is not required, to be collected. This is done through the use of the collection device.

In accordance with a concomitant feature of the invention, the collected bonding agent is returned to the bonding agent reservoir by a recycling device which is included within the device for applying bonding agent.

All of the details and advantages disclosed in connection with the process according to the invention are equally advantageous for the apparatus according to the invention, and vice versa.

Other features which are considered as characteristic for the invention are set forth in the appended claims and can be combined with one another in any technically appropriate way so as to implement further configurations of the invention.

Although the invention is illustrated and described herein as embodied in a process and an apparatus for producing a honeycomb body, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, perspective view illustrating a process step of applying bonding agent;

FIG. 2 is an elevational view showing a structure of a device for applying bonding agent;

FIG. 3 is a sectional view of a printing device at various times, according to another exemplary embodiment for generating bonding agent drops;

FIG. 4 is a fragmentary, elevational view of a bonding agent application according to a preferred embodiment of the process of the invention;

FIG. 5 is a sectional view showing an example of two connected layers;

FIG. 6 is a block diagram of an apparatus according to the invention for the production of honeycomb bodies;

FIG. 7 is a perspective view of examples of a possible application of bonding agent based on the example of a helical honeycomb body; and

FIG. 8 is an elevational view showing details of an application of bonding agent according to a further preferred embodiment of the process according to the invention.

### DESCRIPTION OF THE PREFERRED EMBODIMENTS

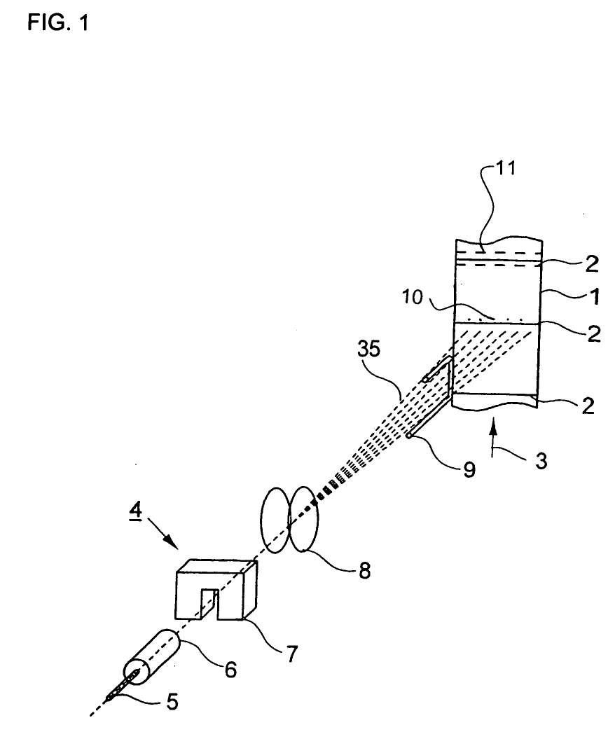

Referring now to the figures of the drawings in detail and first, particularly, to FIG. 1 thereof, there is seen a diagrammatic view illustrating, in principal, a process step of applying bonding agent to a layer from which, together with other layers, a honeycomb body is subsequently to be produced. One such layer, in particular an at least partially structured layer 1 with symbolically indicated structure extremities 2, i.e. structure minima and structure maxima, is moved in a direction of movement 3 relative to a device 4 for applying bonding agent. The device 4 for applying bonding agent includes a piezoelectric element 5, a nozzle 6, a charging device 7, a deflection device 8 and a collection device 9.

In this case, the nozzle 6 is supplied with the bonding agent at a pressure of 2.5 bar or more. The nozzle 6 is set in oscillation by the piezoelectric element 5, at which a high-frequency AC voltage is present. Oscillation frequencies of more than 50 kHz are preferred in this case, preferably more than 60 kHz, and particularly preferably 100 kHz or more. As a result, a continuous jet 35 of bonding agent drops leaves the nozzle 6. This drop jet 35 is electrostatically charged in the charging device 7. The bonding agent drops which have been electrostatically charged in this way are deflected by the deflection device 8 through the application of an electrostatic field. FIG. 1 shows the drop jet 35 with various deflections. As a result, it is possible to produce not just bonding agent dots 10 on the layer 1 but also bonding agent lines 11. It is particularly preferable for the bonding agent, i.e. the bonding agent dots 10 or bonding agent lines 11, to be applied directly adjacent a structure extremity 2. Consequently, the application of bonding agent is still in the region of the apex of the structure and not in the region of the side flank of the structure, but rather directly adjacent the structure extremity 2. During subsequent winding from at least partially structured layers 1 and substantially smooth layers, this leads to the structure extremity 2, by way of which the at least partially structured layer 1 slides over the substantially smooth layer, not being provided with bonding agent, so that sliding friction is reduced as compared to winding with glue applied to the structure extremities 2.

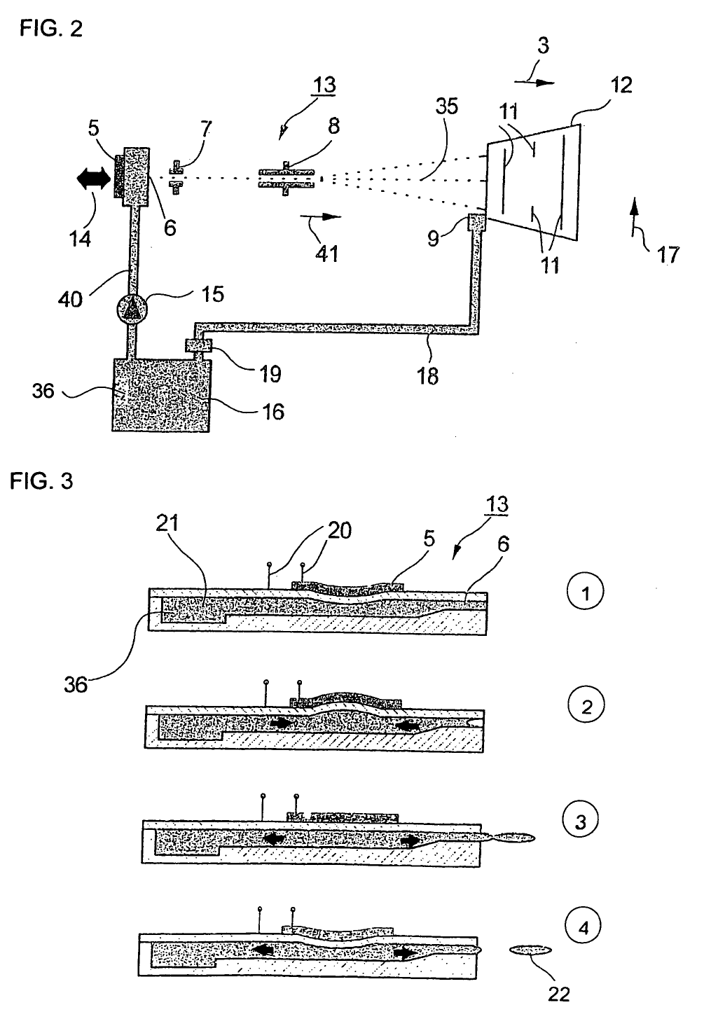

FIG. 2 diagrammatically illustrates a further exemplary embodiment of the device 4 for applying bonding agent. In this case, a substantially smooth layer 12 is moved past a printing device 13 in the direction of movement 3, with the printing device 13 applying bonding agent 36 in the form of a drop jet 35 in an application direction 41. In this case, the application direction 41 is substantially perpendicular to the direction of movement 3 of the layer 12. The printing device 13 includes a piezoelectric element 5, a charging device 7, a deflection device 8 and a collection device 9. The piezoelectric element 5 is operated with a high-frequency AC voltage, which leads to the piezoelectric element 5 oscillating in an oscillation direction 14. Through the use of a high-pressure pump 15, bonding agent from a bonding agent reservoir 16 is passed to a nozzle 6 at high pressure through a feed device or line 40. The oscillations of the piezoelectric element 5 generate a high-frequency continuous or quasi-continuous drop jet 35 from the piezoelectric element 5. These drops 35 are electrostatically charged in the charging device 7 and electrostatically deflected in the deflection device 8.

FIG. 2 shows various diversions for the drop jet 35. The diversions are effected by applying respective voltages to the deflection device 8 and the charging device 7. As a result, the drop jet 35 can be moved relative to the layer 1, 12. In the present exemplary embodiment, lines 11 of bonding agent are produced on the substantially smooth sheet-metal layer 12, which is illustrated in perspective in the drawing. It is possible in this case to produce very different lengths of the lines 11 of bonding agent. It is possible to generate lines 11 of bonding agent in various lengths with respect to a transverse direction 17, which runs transversely to the direction of movement 3, and at different positions with respect to the transverse direction 17. This is done by applying a corresponding AC voltage to the deflection device 8. If a continuous line 11 of bonding agent is not to be generated, drops which would impinge between the partial lines have to be deflected into the collection device 9. As a result, these bonding agent drops do not strike the layer 1, 12. The bonding agent drops which have been collected in the collection device 9 are returned to the bonding agent reservoir 16 through a recycling device or line 18 and, if appropriate, a filter 19.

The possible options disclosed herein for applying bonding agent to substantially smooth layers 12 are equally valid for at least partially structured layers 1.

The examples shown in FIGS. 1 and 2 substantially involve a device 4 for applying bonding agent which operates according to the continuous-inkjet process. In the second exemplary embodiment, shown in FIG. 3, a printing device 13 which operates according to the drop-on-demand system is used. A system of this type does not continuously generate high-frequency oscillation of a nozzle and therefore a quasi-continuous drop jet, but rather individual drops 22 are generated by individual pulses. FIG. 3 shows the same printing device 13 at various times 1 to 4. The printing device 13 includes a piezoelectric element 5, which can be provided with an electric voltage pulse by contacts 20. The generation of drops is diagrammatically indicated at the four different times 1 to 4. At time 1, the piezoelectric element 5 is in an at-rest position. A nozzle 6 and a feed line 21 are filled with bonding agent 36. In step 2, a voltage pulse is being applied to the piezoelectric element 5 through the contacts 20, which leads to deflection of the piezoelectric element 5. This results in a movement of the bonding agent 36 as is symbolically illustrated by two arrows. In step 3, the voltage pulse in the piezoelectric element 5 has disappeared again, so that it has already at least partially been deformed back into its original shape. This leads to a movement of the bonding agent 36 as is indicated by arrows. In step 3, a drop 22 is ejected but has not yet been detached from the bonding agent 36 in the nozzle 6. This only takes place in step 4, in which the piezoelectric element 5 is once again in the at-rest position as at time 1. A released bonding agent drop 22 leaves the nozzle 6. It is possible to print a line formed of bonding agent 35 on the layer 1, 12, given suitable dimensioning of the distance between the nozzle 6 and the layer 1, 12, and by using a multiplicity of these printing units 13 and taking into account a suitable overlap between individual printing units 13.

Gaps can be produced in these lines by not actuating individual printing devices 13 at a specific time and therefore not emitting a drop 22 of bonding agent at that time, while other printing units 13 continue to operate and emit drops 22 of bonding agent.

Another method is the bubble-jet method, in which a boiling film of the bonding agent 36 is produced by briefly heating the nozzle 6. This film generates a vapor bubble which throws a drop 22 of bonding agent 36 out of the nozzle 6. The process is known from the prior art and also represents a drop-on-demand process.

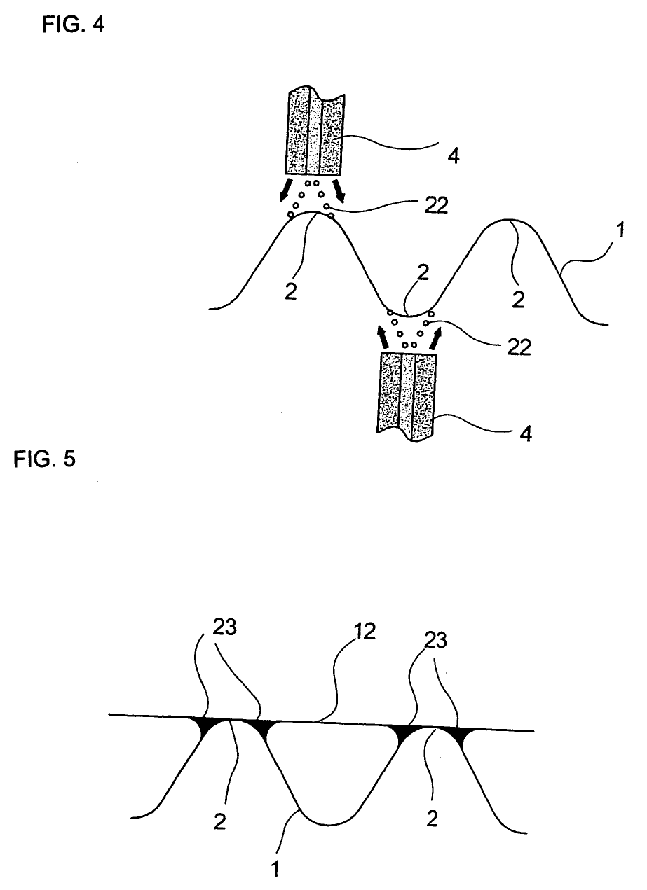

FIG. 4 diagrammatically illustrates details of bonding agent application in accordance with a preferred embodiment of the process of the invention. In this case, a bonding agent is applied in the form of bonding agent drops 22 to an at least partially structured layer 1. The at least partially structured layer 1 in the present example is structured in sinusoidal form, but it would equally be possible to use triangular corrugations or other structures. The bonding agent is applied to the at least partially structured layer 1 by the device 4 for the application of bonding agent. The bonding agent is applied in regions which are adjacent structure extremities 2. Specifically, if a honeycomb body is constructed from at least partially structured sheet-metal layers 1 and, if appropriate, substantially smooth layers 12, the layers 1, 12 move relative to one another during the winding or intertwining of the layers 1, 12. This leads to the at least partially structured layers 1 slipping on the substantially smooth layers 12. If bonding agent were to be applied directly to the structure extremities 2, this would increase sliding friction between the at least partially structured layer 1 and the substantially smooth layer 12 and thereby make the winding or intertwining more difficult. However, the at least partially structured layers 1 and substantially smooth layers 12 have to be connected to one another to construct a honeycomb body according to the invention. This is often done by a soldering operation, more specifically a brazing operation, to connect the layers to one another. The brazing is carried out in the region of the structure extremities 2, so that upon contact between the at least partially structured layer 1 and the substantially smooth layer 12, substantially triangular brazing pockets are formed on both sides of the structure extremity 2. This means that application of brazing material in the region of the structure extremities 2 is required in order to achieve a connection between the at least partially structured layer 1 and the substantially smooth layer 12. Therefore, one of the major benefits of the present invention is that a bonding agent can be applied directly adjacent the structure extremities 2. This means that on one hand the sliding friction between the layers 1, 12 during winding or intertwining is reduced and on the other hand brazing material can be applied in the region of the structure extremities. In this way it is possible to produce a permanent and high-quality connection between the layers 1, 12 without the winding or intertwining becoming more difficult. For this purpose, in accordance with the invention, the bonding agent is applied directly adjacent the structure extremities 2.

FIG. 5 shows, by way of example, two connected layers 1, 12. In this case, an at least partially structured layer 1 has been connected to a substantially smooth layer 12. The at least partially structured layer 1 has structure extremities 2, at which the at least partially structured layer 1 bears against the substantially smooth layer 12. The process according to the invention led to the formation of brazing pockets 23, which connect the at least partially structured layer 1 to the substantially smooth layer 12.

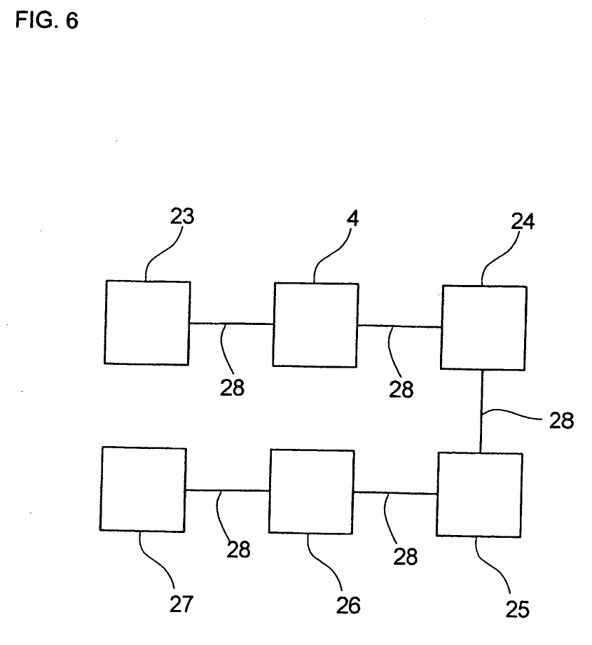

FIG. 6 diagrammatically illustrates a structure of an apparatus for producing honeycomb bodies. FIG. 6 shows a device 23 for providing at least one at least partially structured metallic layer and, if appropriate, at least one substantially smooth metallic layer. This device can, for example, carry out unwinding and severing and, if appropriate, structuring of sheet-metal layers from coils of smooth sheet-metal foils or can also suitably prepare fiber material, i.e. at least provided in a defined length, and structure it if appropriate. This device 23 makes available the required at least partially structured layers or else, if appropriate, substantially smooth layers. In this case, the device may have a structuring device, which is not shown and is used to produce a substantially structured layer from a smooth layer which, by way of example, is unwound from a coil. Furthermore, it is possible to provide a microstructuring device, which forms microstructures in the substantially smooth layer.

A device 4 for applying bonding agent follows the device 23 for providing layers. Reference is made to the description given above for details as to the device 4 for applying bonding agent. The device 4 for applying bonding agent is followed by a stacking device 24, in which stacks of substantially smooth and at least partially structured sheet-metal layers are formed. The stacking device 24 is followed by an intertwining device 25, in which one or more stacks produced in the stacking device 24 are intertwined with one another. In this way it is possible, for example, to produce honeycomb bodies which are in an S shape or an involute shape. It is equally also possible not to provide the stacking device 24 but instead to wind up one at least partially structured layer or alternatively a plurality of at least partially structured and substantially smooth layers, for example, to form a helical honeycomb body.

The intertwining device 25 is followed by a brazing material application device 26, in which brazing material in powder form is introduced into the wound honeycomb body. The brazing material application device is followed by a treatment device 27, in which a heat treatment is carried out, during which the brazing material that has been introduced is melted and connects the layers 1, 12 to one another. The individual devices 23, 4, 24, 25, 26, 27 are connected to one another by a connection device 28 which allows interim products to be transported from one device to the next. In the present example, the application of brazing material in the brazing material application device 26 takes place following the stacking and intertwining in the stacking device 24 and intertwining device 25. However, it is equally possible and in accordance with the invention for the application of the brazing material in powder form to be applied before the stacking and/or intertwining.

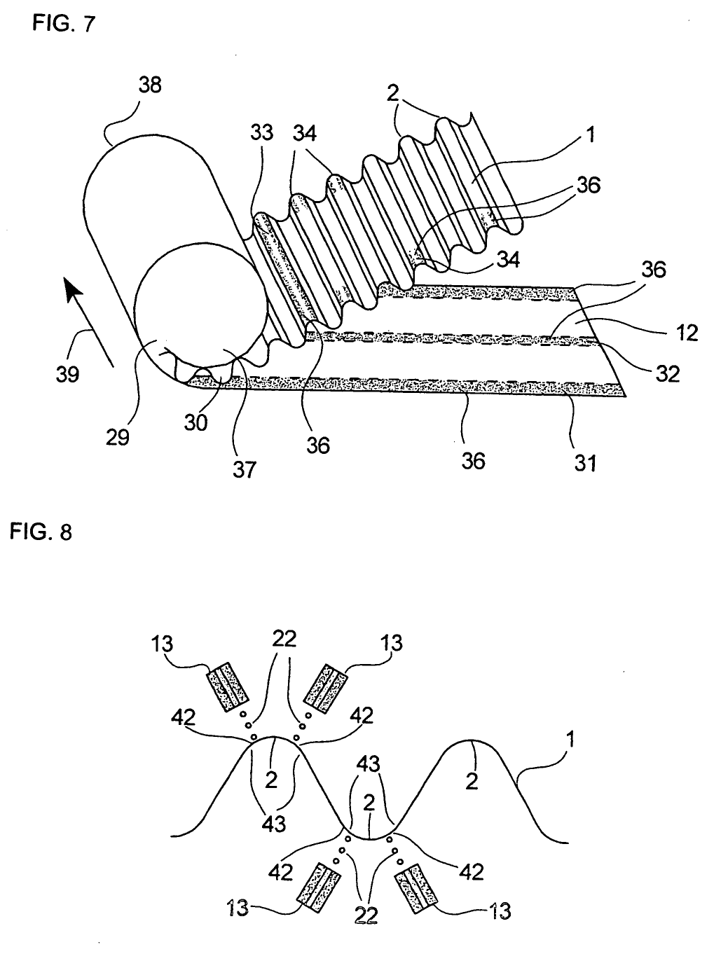

FIG. 7 uses the example of a helically wound honeycomb body to show various options for applying bonding agent 36, which are possible through the use of the process according to the invention. A helically wound honeycomb body 29 has been wound helically from an at least partially structured layer 1 and a substantially smooth layer 12. The honeycomb body 29 has passages or channels 30 which extend through the honeycomb body 29. Media can flow through the honeycomb body 29 from a first end side 37 to a second end side 38 in a direction of flow 39. FIG. 7 shows various options as to how bonding agent can be applied both to the at least partially structured layer 1 and to the substantially smooth layer 12 using the process according to the invention. By way of example, the bonding agent 36 can be applied as an end-side bonding agent strip 31 or as an inner bonding agent strip 32. When the bonding agent 36 is being applied both to the at least partially structured layer 1 and to the substantially smooth layer 12, it is possible to form continuous bonding agent strips 33. In this case it is particularly preferable for these strips to be formed directly adjacent the structure extremities 2 of the at least partially structured layer 1. In this case, a region of the structure which corresponds to the structure extremity 2 itself is not provided with bonding agent 36. Furthermore, it is possible for only subregions of the at least partially structured layer 1 to be provided with bonding agent. In this case, it is possible for subregions 34 with bonding agent 36 to be formed both at the end sides and in the interior, as seen in the direction of flow. For example, it is also possible for each structure to have a plurality of regions provided with bonding agent 36. In all of these examples, the bonding agent is applied in accordance with the invention in the form of drops, preferably in the form of a drop jet, and particularly preferably through the use of a printing device, such as for example a continuous-inkjet printing device.

During a subsequent application of brazing powder, this powder continues to adhere to the subregions 31, 32, 33, 34 to which bonding agent 36 has been applied, so that the layers 1, 12 are connected to one another in these subregions 31, 32, 33, 34.

FIG. 8 shows another example of an advantageous configuration of the process according to the invention. In this case, bonding agent in the form of bonding agent drops 22 is applied to an at least partially structured layer 1. The application of bonding agent in this case takes place substantially perpendicularly to a surface 42 of subregions 43 that are to be provided with bonding agent 36, i.e. the bonding agent is applied in a direction which is substantially the surface normal to the surface 42 that is to be provided with bonding agent. This is done by suitable adjustment of the printing devices 13. The subregions 43 which are to be provided with bonding agent 36 are located adjacent the structure extremities 2.

The process according to the invention and the apparatus according to the invention for producing honeycomb bodies 29 advantageously allow a very accurate application of bonding agent 36 to the regions in which a connection to adjacent layers is subsequently to be made. In this case, it is particularly preferable for bonding agent 36 to be applied through the use of a printing technique, in particular including to the flank or side regions which are directly adjacent a structure extremity 2. As a result, it is preferably possible to keep the structure extremity 2 itself clear of bonding agent 36, so that it is easier to carry out subsequent winding or intertwining of the layers 1, 12. With the process according to the invention and the apparatus according to the invention, it is possible to form honeycomb bodies 29 which have a flexibility that is inhomogenous over the direction of flow 39 and/or substantially transversely to the direction of flow 39.

I claim:

1. A process for producing a honeycomb body from layers, which comprises the following steps:
a) providing at least one at least partially structured layer and/or substantially smooth layer;
b) applying bonding agent in drop form at least to at least one subregion of the at least one at least partially structured layer and/or substantially smooth layer;
c) producing a honeycomb body from the at least one at least partially structured layer and/or substantially smooth layer;
d) applying brazing material to the at least one at least partially structured layer and/or substantially smooth layer;
e) carrying out a heat treatment step on the honeycomb body; and
f) substantially maintaining adherence between the at least one at least partially structured layer and/or substantially smooth layer provided with brazing material and the at least one subregion provided with bonding agent.

2. The process according to claim 1, which further comprises carrying out step c) by stacking at least one at least partially structured layer and at least one substantially smooth layer to form at least one stack.

3. The process according to claim 2, which further comprises intertwining the at least one stack of layers to form the honeycomb body.

4. The process according to claim 1, which further comprises carrying out step c) by winding-up at least one at least partially structured layer and/or substantially smooth layer to form the honeycomb body.

5. The process according to claim 1, which further comprises carrying out step d) by providing the honeycomb body with brazing material in powder form after step b) and before step e).

6. The process according to claim 1, wherein the at least partially structured layer has at least one structure with a structure extremity and side regions, and step b) is carried out by applying the bonding agent in the side regions.

7. The process according to claim 6, wherein the side regions, to which the bonding agent is applied, are near the structure extremity.

8. The process according to claim 1, which further comprises carrying out step b) by printing-on the bonding agent.

9. The process according to claim 1, which further comprises carrying out step b) by applying the bonding agent using a drop-on-demand process.

10. The process according to claim 1, which further comprises carrying out step b) by applying the bonding agent using a bubble-jet process.

11. The process according to claim 1, which further comprises carrying out step b) by applying the bonding agent using a continuous-inkjet process.

12. The process according to claim 1, which further comprises carrying out step b) by applying the bonding agent through a pulse-excited nozzle.

13. The process according to claim 1, which further comprises carrying out step b) by applying the bonding agent through a nozzle excited into high-frequency oscillations.

14. The process according to claim 1, which further comprises carrying out step b) by applying the bonding agent through a nozzle excited to a pressure of more than 2 bar.

15. The process according to claim 1, which further comprises carrying out step b) by applying the bonding agent through a nozzle excited to a pressure of more than 2.5 bar.

16. The process according to claim 1, which further comprises carrying out step b) by applying the bonding agent through a nozzle excited by a piezoelectric element.

17. The process according to claim 1, which further comprises carrying out step b) by applying the bonding agent through a nozzle excited at a frequency of at least 50 kHz.

18. The process according to claim 1, which further comprises carrying out step b) by applying the bonding agent through a nozzle excited at a frequency of at least 60 kHz.

19. The process according to claim 1, which further comprises carrying out step b) by applying the bonding agent through a nozzle excited at a frequency of at least 100 kHz.

20. The process according to claim 1, which further comprises electrostatically charging and electrostatically deflecting the bonding agent drops.

21. The process according to claim 20, which further comprises electrostatically diverting into a collection device and recycling, bonding agent drops not to be applied to the layers.

22. The process according to claim 20, which further comprises at least partially achieving positioning of the bonding agent on the layers by targeted electrostatic deflection of the bonding agent drops before they strike the layers.

23. The process according to claim 1, which further comprises generating the bonding agent drops by briefly heating the bonding agent above its boiling point in a nozzle.

24. The process according to claim 1, which further comprises selecting at least some of the layers from the group consisting of metallic layers, sheet-metal layers and metallic fiber layers.

25. The process according to claim 1, which further comprises forming at least some of the layers from composite material.

26. The process according to claim 25, which further comprises forming the composite material of ceramic fibers and metallic material.

27. The process according to claim 26, which further comprises selecting the metallic material from the group consisting of metallic fibers and sheet-metal layers.

28. The process according to claim 1, which further comprises carrying out step b) by applying the bonding agent drops on the layer with a mean diameter of from 0.05 to 0.7 mm.

29. The process according to claim 1, which further comprises carrying out step b) by applying the bonding agent drops on the layer with a mean diameter of from 0.1 to 0.4 mm.

30. The process according to claim 1, which further comprises carrying out step b) by applying the bonding agent drops on the layer with a mean diameter of from 0.1 to 0.3 mm.

31. The process according to claim 1, which further comprises carrying out step b) by applying the bonding agent in an application direction substantially perpendicular to a direction of movement of the layers.

32. The process according to claim 1, which further comprises carrying out step b) by applying the bonding agent in an application direction substantially perpendicular to a surface of the at least one subregion to be provided with bonding agent.

33. An apparatus for producing a honeycomb body, the apparatus comprising:
a) a device for providing at least one at least partially structured layer and/or substantially smooth layer;
b) a device for applying bonding agent at least to at least one subregion of the at least one at least partially structured layer and/or substantially smooth layer, said device for applying bonding agent including at least one printing device for printing the bonding agent onto the at least one subregion, a bonding agent reservoir and a feed device for feeding bonding agent to said printing device;
c) a device for generating a honeycomb body from the at least one at least partially structured layer and/or substantially smooth layer;
d) a brazing material application device for providing the honeycomb body with brazing material substantially continuing to adhere to the at least one subregion having been provided with bonding agent; and
e) a treatment device for heat treating the honeycomb body.

34. The apparatus according to claim 33, wherein said device for generating a honeycomb body includes a stacking device for stacking at least one at least partially structured layer and at least one substantially smooth layer to form at least one stack.

35. The apparatus according to claim 34, wherein said device for generating a honeycomb body includes an intertwining device for intertwining the at least one stack of metallic layers.

36. The apparatus according to claim 33, wherein said device for generating a honeycomb body includes a winding-up device for winding up at least one at least partially structured layer and/or at least one substantially smooth layer to form a honeycomb body.

37. The apparatus according to claim 33, wherein said printing device is a drop-on-demand printing device.

38. The apparatus according to claim 33, wherein said printing device is a bubble-jet printing device.

39. The apparatus according to claim 33, wherein said printing device is a continuous-inkjet printing device.

40. The apparatus according to claim 33, wherein said printing device has a nozzle to be excited into high-frequency or pulse-like oscillations, for applying the bonding agent.

41. The apparatus according to claim 40, wherein said nozzle has a piezoelectric element.

42. The apparatus according to claim 33, wherein said printing device has a charging device for electrostatically charging the bonding agent and a deflecting device for deflecting the bonding agent.

43. The apparatus according to claim 33, wherein said device for applying bonding agent includes a collection device for collecting bonding agent not having been applied.

44. The apparatus according to claim 43, wherein said device for applying bonding agent includes a recycling device returning the bonding agent collected in said collection device to said bonding agent reservoir.
